(19) United States
(12) Patent Application Publication
(10) Pub. No.: US 2019/0289109 A1
(43) Pub. Date: Sep. 19, 2019

(54) Apparatus and Methods for Voice Privacy with Headphones

(71) Applicant: Gregory Thomas Umhoefer, Hartland, WI (US)

(72) Inventor: Gregory Thomas Umhoefer, Hartland, WI (US)

(21) Appl. No.: 16/351,492

(22) Filed: Mar. 12, 2019

Related U.S. Application Data
(60) Provisional application No. 62/642,139, filed on Mar. 13, 2018.

(51) Int. Cl. H04M 1/19; G10K 11/178; H04R 1/08

(52) U.S. Cl. CPC H04M 1/19; H04R 1/083; G10K 11/17861

(57) ABSTRACT

Apparatus and methods for voice privacy with headphones, the invention is directed to an apparatus positionable over a user's mouth configured to reduce the audible volume of the user's voice to other persons within a close proximity of the user, to partially block outside noise from reaching the microphone, and to enable the microphone to pick up the user's voice with a high level of audio quality. The apparatus has an open-end which makes contact with a user's face and a pocket in which the microphone portion of a pair of headphones is removably receivable.

### CROSS-REFERENCE TO RELATED APPLICATIONS

See Application Data Sheet.

### STATEMENT REGARDING FEDERALLY SPONSORED RESEARCH OR DEVELOPMENT

Not Applicable

REFERENCE TO SEQUENCE LISTING, A TABLE, OR A COMPUTER PROGRAM LISTING COMPACT DISC APPENDIX

Not Applicable

### BACKGROUND OF THE INVENTION

With the prevalence of mobile phones and the all-too-common scenario of being in a public place and thrust into a stranger's personal business as she talks to a person on the other end, whether attempting to be discreet or not, or the situation in which an important call is coming through on your mobile phone and you are in a crowded subway car, the reality of having a private telephone conversation and reducing extraneous environmental noise is almost impossible.

There is prior art that attempts to allow a user to have a private telephone conversation while maintaining high sound quality or blocking extraneous environmental noise. For examples, see U.S. Pat. Nos. 7,783,034; 8,243,944; and 9,794,386 as well as U.S. Pat. App. No. 2002/0077838. The main problem with all of these examples is that they don't function with a user-supplied pair of headphones, which a significant percentage of mobile phone users carry or at least own.

Headphones with a microphone provide an advantage in that at least the voice of the person on the other side of the phone is being heard clearly, but the microphone is exposed to external noise and is as likely to pick up the conversation at the restaurant table next to you as it is your private discussion. However, it is impossible to have a private conversation with only a pair of headphones, as the user's voice can be heard by persons nearby.

Therefore, there is a need for a voice privacy apparatus configured to cover a user's mouth during a phone conversation, while recording a voice message, and/or delivering other communication or notes through speech-to-text that is configured to removably receive the microphone portion of a pair of headphones. An effective apparatus provides the following benefits: blocks extraneous environmental noise, reduces the audible volume of the user's voice to persons nearby, and still allows the user's own voice to be transmitted with a high level of audio quality.

### BRIEF SUMMARY OF THE INVENTION

The present invention relates to an apparatus positionable over a user's mouth configured to reduce the audible volume of the user's voice to other persons within a close proximity of the user, to partially block outside noise from reaching the microphone, and to enable the microphone to pick up the user's voice with a high level of audio quality. The apparatus has an open-end which makes contact with a user's face and a pocket in which the microphone portion of a pair of headphones is removably receivable.

### BRIEF DESCRIPTION OF THE SEVERAL VIEWS OF THE DRAWING

FIG. 1 is a perspective view of the voice privacy apparatus positioned on a user.

FIG. 2 is a bottom perspective view of the voice privacy apparatus shown in FIG. 1 with motion lines illustrating how the microphone portion of a pair of headphones is positioned in the apparatus.

FIG. 3 is a bottom perspective view of the voice privacy apparatus shown in FIG. 1 after the microphone has been positioned in the apparatus.

FIG. 4A is a front elevation view of the voice privacy apparatus shown in FIG. 1.

FIG. 4B is a cut-away view of the voice privacy apparatus shown in FIG. 4A along line 4B-4B.

FIG. 5 is a rear perspective view of the voice privacy apparatus shown in FIG. 1.

### DETAILED DESCRIPTION OF THE INVENTION

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

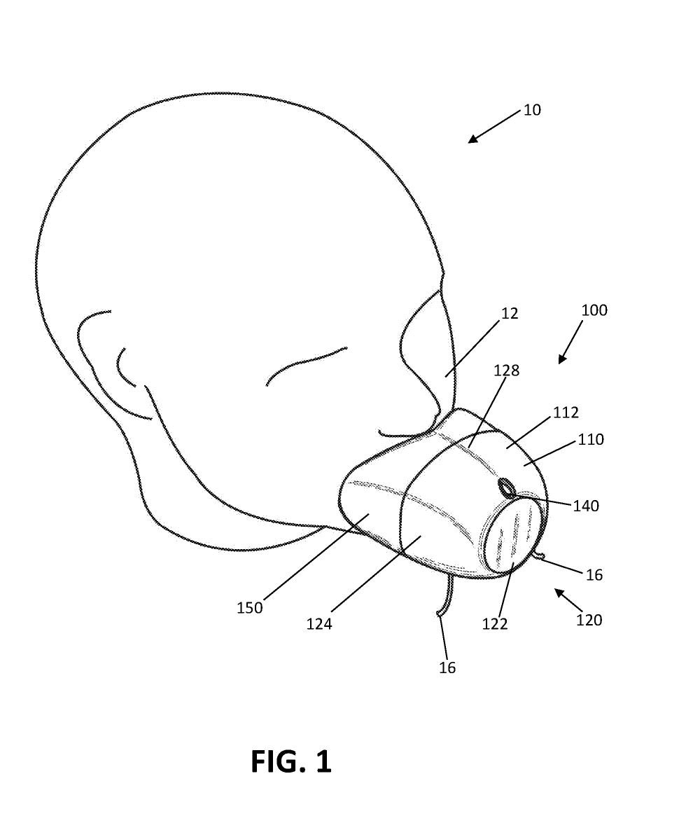

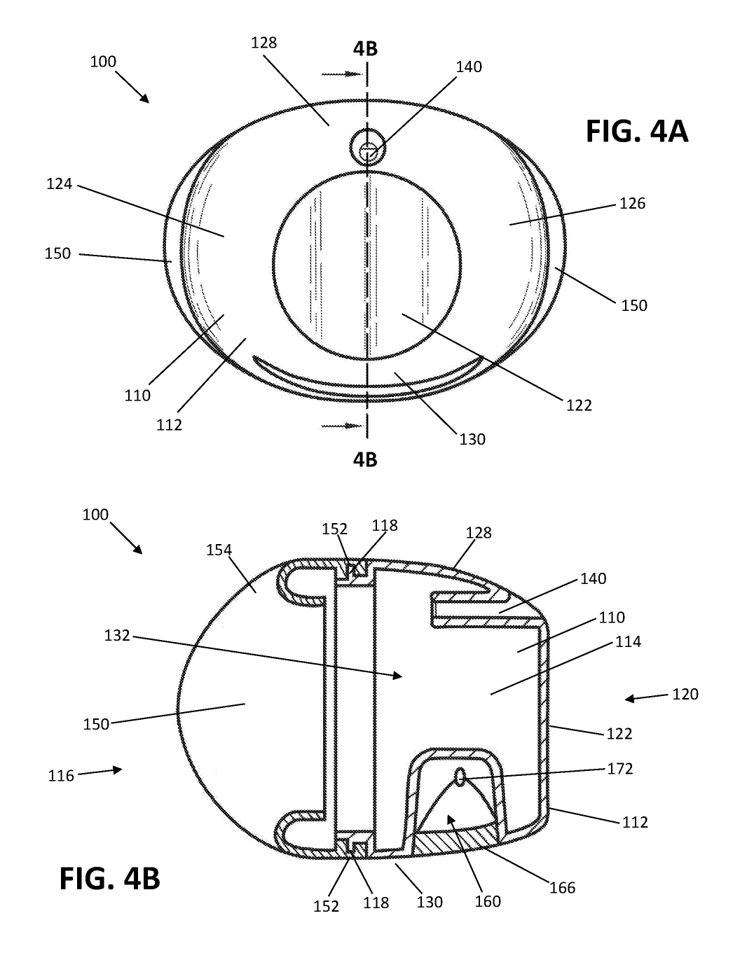

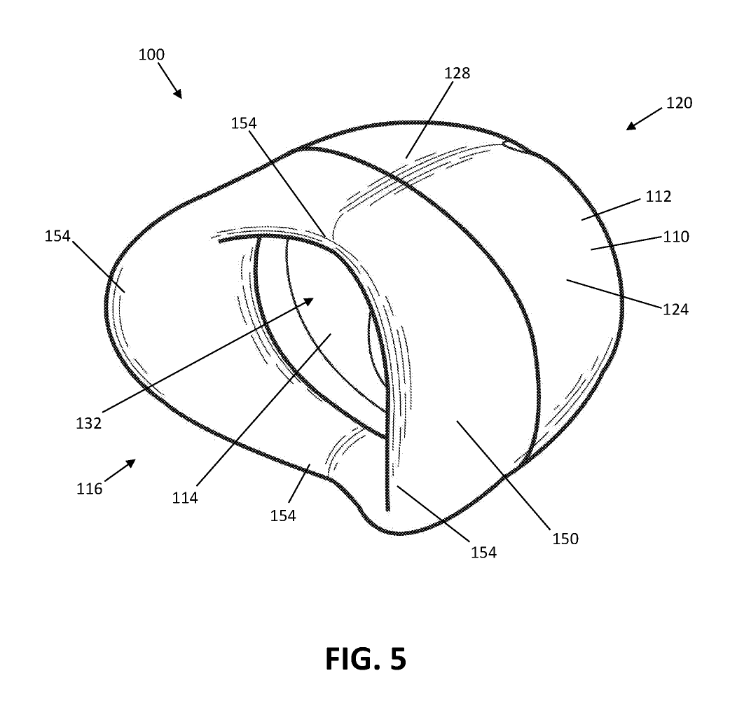

FIGS. 1-5 show an exemplary embodiment 100 of a voice privacy apparatus according to the present invention. The voice privacy apparatus 100 preferably comprises a body 110, a gasket 150, and a pocket 160.

The apparatus 100 has a substantially open-end portion 116 and a substantially closed-end portion 120. The open-end portion 116 is shaped and configured to follow the contours around the mouth (hidden) of a user 10 (see FIG. 1).

The body 110 is preferably dome-shaped having an exterior surface 112, an interior surface 114, a front side 122, a right side 124, a left side 126, a top side 128, and a bottom side 130, which, along with the gasket 150, define a cavity 132. The body 110 more preferably has a shape similar to that of an exterior elliptical dome with a substantially flat front side 122. The flat portion of the front side 122 is a convenient location for a logo or sticker, and also allows the apparatus 100 to be placed with the flat side down on a desk so that it will not roll around and also keep the open-end portion 116 free of crumbs or other desk debris. The flat portion of the front side 122 could also be used to affix a device (not pictured) which would allow the user 10 to more easily hold or grip the apparatus 100 using the fingers.

A tube 140 preferably extends inward from the exterior surface 112 at the front side 122 into the cavity 132. Preferably the ratio of the length of the tube 140 to the diameter of the tube 140 is approximately 8:1. For example, if the length is approximately one inch, the diameter will be approximately one eighth of an inch. The exemplary embodiment 100 has one tube 140, but other embodiments could have two or more tubes.

The gasket 150 preferably comprises a compliant material and is shaped to follow the rim 118 of the body 110. The gasket 150 preferably has a track 152 configured to receive the rim 118 and a flange portion 154 configured to provide cushion as a user 10 places the voice privacy apparatus 100 against the face 12 (see FIG. 1).

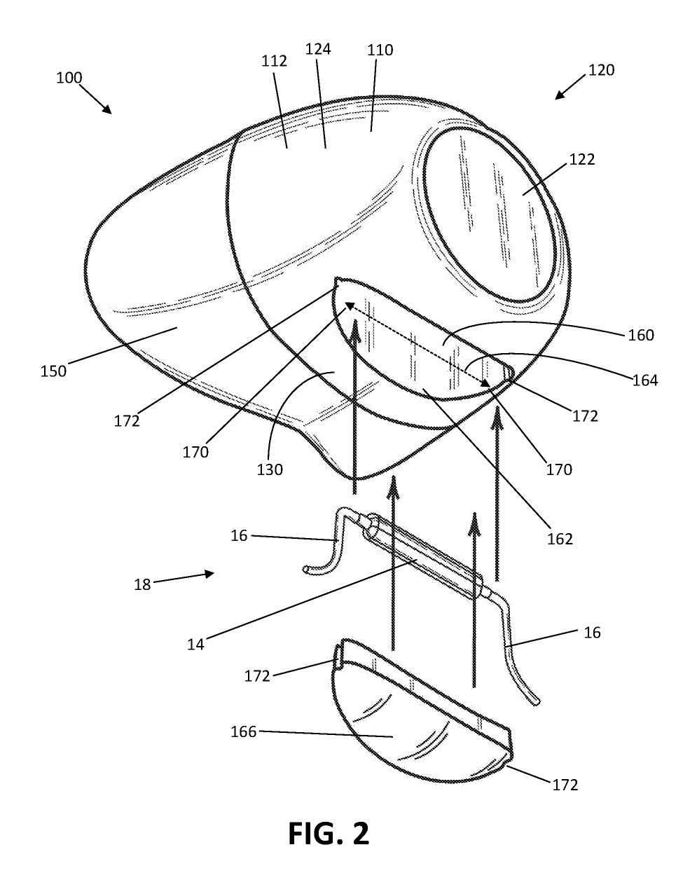

The pocket 160 preferably projects inward from the exterior surface 112 into the cavity 132 and has an open-end 162. The pocket 160 may comprise a compliant material (e.g., the same or similar material as that comprising the gasket 150); however, other materials are contemplated. The pocket 160 preferably has an interior elliptical shape with a long dimension 164 (see FIG. 2) extending along the bottom side 130 of the body 110. The transverse orientation of the pocket 60 across the bottom side 130 provides a convenient alignment with the microphone 14 of a user-supplied pair of headphones 18 as described further below.

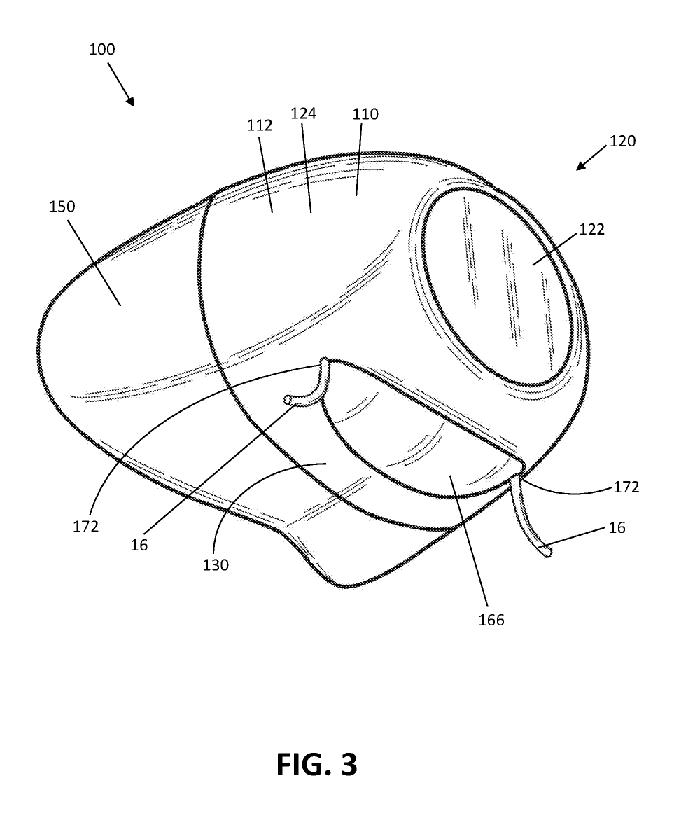

The pocket 160 further comprises a plug 166 that fits across the open-end 162 of the pocket 160. At each end 170 of the pocket 160 there is preferably a relief 172 sized and configured to retain a portion of a cord 16 on either side of the microphone 14 of the user-supplied pair of headphones 18 which permits the pocket 160 to close with an air-tight seal. With the pocket 160 closed (see FIG. 3), unwanted environmental noise is partially blocked and the microphone 14 is better able to pick up the voice of the user 10.

An example of user-supplied headphones 18 with a microphone 14 is EarPods™ headphones sold by Apple, Inc. in which the microphone portion is incorporated within the cord of the right earphone. Although the exemplary embodiment of the voice privacy apparatus 100 is described with the pocket 160 located on the bottom side 130 of the body 110 to accept the microphone portion of a pair of headphones like EarPods™ headphones, the pocket 160 may be located at any location and positioned in any manner on the apparatus 100 which allows for ease of reception of the microphone 14 of the user-supplied headphones 18.

A method of providing voice privacy is described as follows. Providing a voice privacy apparatus 100 having a body 110, a gasket 150, and a pocket 160. The apparatus 100 preferably has a substantially open-end portion 116 and a substantially closed-end portion 120. The body 110 and the gasket 150 define a cavity 132 into which one or more tubes 140 in the closed-end portion 120 extend to allow ventilation within the cavity 132. The gasket 150 is preferably comprised of a pliable material and positioned along a rim 118 of the body 110 and is configured to make contact with the face 12 of a user 10. The pocket 160 extends into the cavity 132 of the body 110 from the exterior surface 112 and has a plug 166 which is configured to enclose the microphone 14 of a user-supplied pair of headphones 18 to be received therein. Placing the microphone 14 of a user-supplied pair of headphones 18 into the pocket 160. Enclosing the microphone 14 using the plug 166 such that the cord 16 fits in the relief spaces 172 and an air-tight seal is formed. Placing the voice privacy apparatus 100 around the mouth and the gasket 150 against the face 12 of a user 10. Speaking into the voice privacy apparatus 100.

The foregoing is considered as illustrative only of the principles of the invention. Furthermore, because numerous modifications and changes will readily occur to those skilled in the art, it is not desired to limit the invention to the exact construction and operation shown and described. While the preferred embodiment has been described, the details may be changed without departing from the invention.

What is claimed is:

1. A voice privacy apparatus comprising:
a substantially open-end orientated toward a user's face and a substantially closed-end orientated away from the user's face;
said open-end having a shape that follows the contours around the user's mouth so that an air-tight seal is formed between the apparatus and the user's face; and
a pocket in which a microphone portion of a pair of headphones is removably receivable.

2. The voice privacy apparatus of claim 1, further comprising one or more tubes allowing air flow between the interior of the apparatus and the exterior of the apparatus.

3. The voice privacy apparatus of claim 1, wherein the pocket is air-tight when the microphone portion of a pair of headphones is inside said pocket.

4. The voice privacy apparatus of claim 1, further comprising a plug that fits across the open-end of the pocket so that the pocket is air-tight when said microphone is inside the pocket and the plug is in place.

5. The voice privacy apparatus of claim 2, wherein the ratio of the length of said tube or tubes to the diameter of said tube or tubes is approximately 8:1.

6. The voice privacy apparatus of claim 2, wherein said tube or tubes project inward from the exterior surface of the apparatus.

7. The voice privacy apparatus of claim 1, wherein said pocket projects inward from the exterior surface of the apparatus.

8. The voice privacy apparatus of claim 1, wherein said pocket has an interior elliptical shape and a long dimension extending along the bottom side of the apparatus.

9. The voice privacy apparatus of claim 1, wherein said pocket has a transverse orientation across the bottom side of the apparatus.

10. The voice privacy apparatus of claim 1, wherein the closed-end portion opposite the open-end portion is substantially flat.

11. A method of providing voice privacy comprising a user:
inserting the microphone portion of a pair of headphones into the pocket of a voice privacy apparatus;
positioning said apparatus around the user's mouth and against the user's face; and
speaking into said apparatus.

12. The method of claim 11, wherein the user encloses said microphone within the pocket such that the pocket is air-tight.

13. The method of claim 11, wherein the user places a plug across the open-end of the pocket to enclose said microphone within the pocket such that the pocket is air-tight.

14. The method of claim 11, further comprising the user resting the apparatus while not in-use on a desk or table by placing the substantially flat closed-end portion on the desk, so that the open-end portion is orientated upward.

15. The method of claim 11, further comprising the user holding the apparatus with the fingers using a device affixed to the substantially flat closed-end portion of the apparatus.
